(19) United States
(12) Patent Application Publication
(10) Pub. No.: US 2026/0127354 A1
(43) Pub. Date: May 7, 2026

(54) GENERATING MEANINGFUL SYSTEM EVENT SUMMARIES USING AN LLM

(71) Applicant: Cisco Technology, Inc., San Jose, CA (US)

(72) Inventors: Sofia Karygianni, Dübendorf (CH); Yannick Weibel, Cugy (CH); Arnaud Quirin, Suresnes (FR); Mohit Dubey, Amsterdam (NL)

(73) Assignee: Cisco Technology, Inc., San Jose, CA (US)

(21) Appl. No.: 18/935,746

(22) Filed: Nov. 4, 2024

(51) Int. Cl. G06F 40/166; G06F 40/279; G06F 40/40

(52) U.S. Cl. CPC G06F 40/166; G06F 40/279; G06F 40/40

(57) ABSTRACT

In one implementation, a device extracts event data from logs generated by one or more entities in a computer network that are indicative of events that occurred in the computer network. The device detects, using the event data, a relationship between the events that occurred in the computer network. The device generates, based on the relationship, a prompt for input to a language model. The device provides the prompt to the language model, to generate a summary of the events that occurred in the computer network.

### TECHNICAL FIELD

The present disclosure relates generally to generating meaningful system event summaries using a large language model (LLM).

### BACKGROUND

As the number of devices, services, and communication mechanisms in a computer network continues to increase, so too does the complexity of the network. This complexity also makes detecting and troubleshooting issues in the network difficult. For instance, poor application performance during a video conference could be attributable to a lack of resources on the endpoint device of a participant in the video conference, to poor network performance (e.g., high packet loss, latency, etc.), or to even problems associated with the application itself (e.g., an overloaded server, etc.).

Network devices, controllers, and monitoring tools produce a vast array of operational and status reports, which are referred to herein collectively as “events.” Commonly, events demand the expertise of a trained operator for interpretation and subsequent action. However, the sheer volume of events generated by most computer networks, coupled with their intricate and underlying interactions, exceeds the capacity for effective human management.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of a user interfacing with a language model;

FIG. 4 illustrates an example architecture for an artificial intelligence (AI) agent;

FIG. 5 illustrates an example architecture for generating meaningful system event summaries using a large language model (LLM); and

FIG. 6 illustrates an example of a simplified procedure for generating meaningful system event summaries using an LLM, in accordance with one or more implementations described herein.

### DESCRIPTION OF EXAMPLE IMPLEMENTATIONS

### Overview

According to one or more implementations of the disclosure, a device extracts event data from logs generated by one or more entities in a computer network that are indicative of events that occurred in the computer network. The device detects, using the event data, a relationship between the events that occurred in the computer network. The device generates, based on the relationship, a prompt for input to a language model. The device provides the prompt to the language model, to generate a summary of the events that occurred in the computer network.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

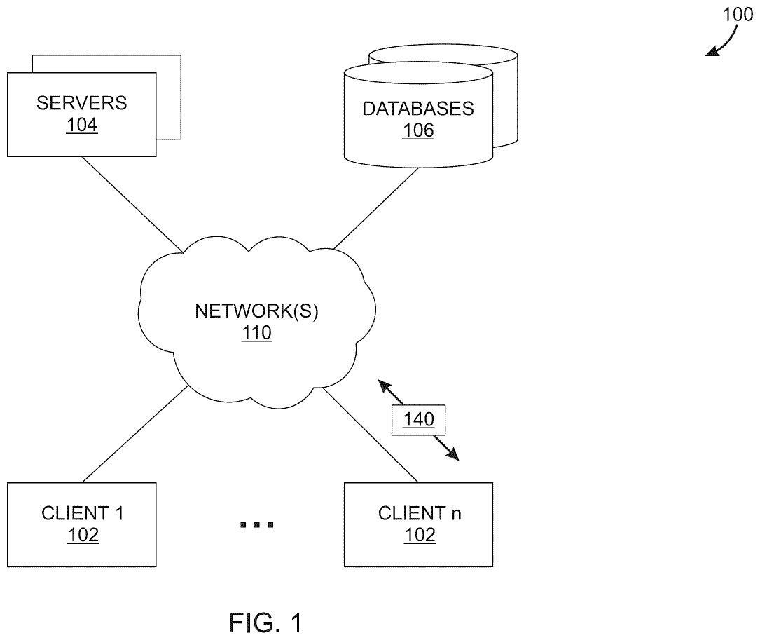

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

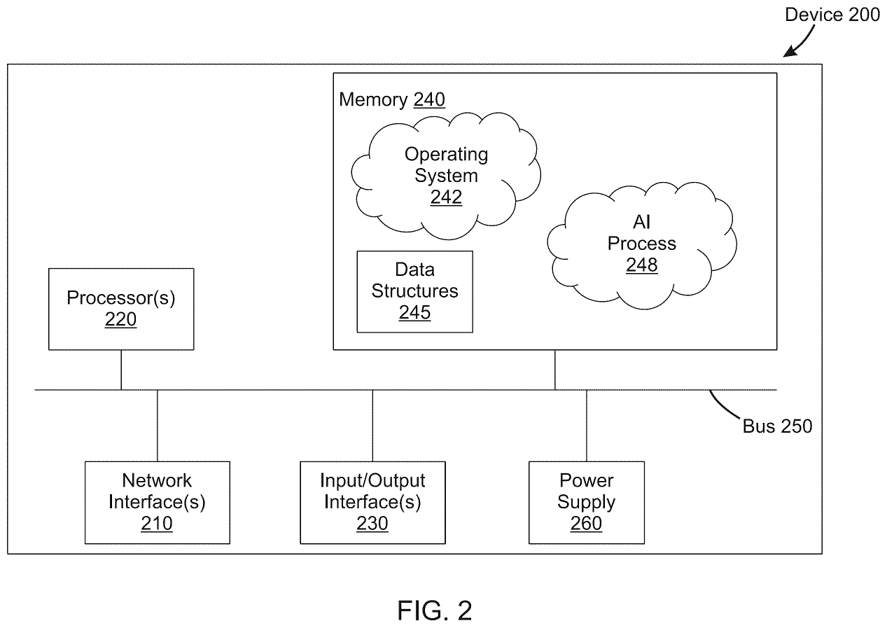

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise an AI process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, AI process 248 may include computer executable instructions that, when executed by processor 220, cause device 200 to perform the techniques described herein. To do so, in some implementations, AI process 248 may utilize AI/machine learning. In general, AI/machine learning is concerned with the design and the development of techniques that take as input empirical data (such as network statistics and performance indicators) and recognize complex patterns in these data. One very common pattern among these techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, AI process 248 may employ and/or be utilized to handle prompts to and/or access of one or more supervised, unsupervised, or semi-supervised AI/machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example AI/machine learning techniques that the AI process 248 can employ and/or be utilized in concert with may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, AI process 248 may also include, or otherwise use or be employed to operate with, one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of machine unlearning, AI process 248 may be a component of, use, and/or be utilized in the management of prompts/access to a generative model to perform layer attribution, perform layer sensitivity assessment, remove capabilities from a previously trained model, retain model performance, etc. based on a conversational input from a user (e.g., voice, text, etc.). Example generative approaches can include, but are not limited to, generative adversarial networks (GANs), large language models (LLMs) and other foundation models, diffusion models, transformer models, and the like.

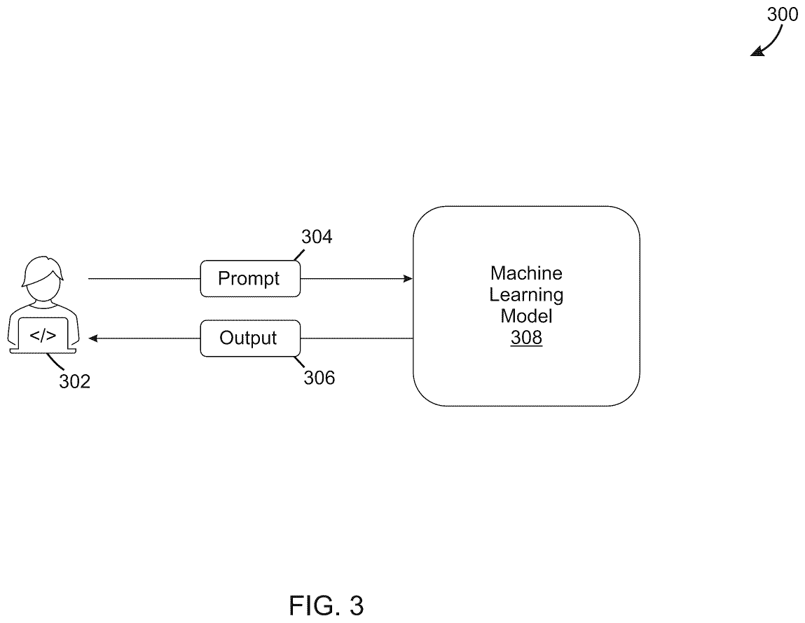

FIG. 3 illustrates an example 300 for interfacing with a language model, in various implementations. In example 300, a user 302 may send a prompt 304 (e.g., a query, a query augmented with additional data, documents, and/or images, etc.) to a generative model 308. The generative model 308 may be configured to process a prompt 304 to generate an output 306 to satisfy the prompt 304.

The generative model 308 may be a model configured to apply its trained algorithms to generate a response (e.g., output 306) based on the prompt 304 provided. For instance, in some cases, generative model 308 may take the form of a large language model (LLM) or other foundation model, diffusion-based model, combinations thereof, or the like.

The output 306 may be the result produced by the generative model 308 (e.g., by the application of the generative model 308 to the prompt 304). This output can vary depending on the model's configuration and the task at hand. For example, the output 306 may include one or more of a generated and/or synthesized image, a text response, a classification and/or prediction, etc.

As noted above, AI agents are also capable of interacting with generative models, such as generative model 308, which may be integrated directly into the agent or accessed via an API. Indeed, the recent breakthroughs in large language models (LLMs), such as GPT-4, as well as other generative models, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

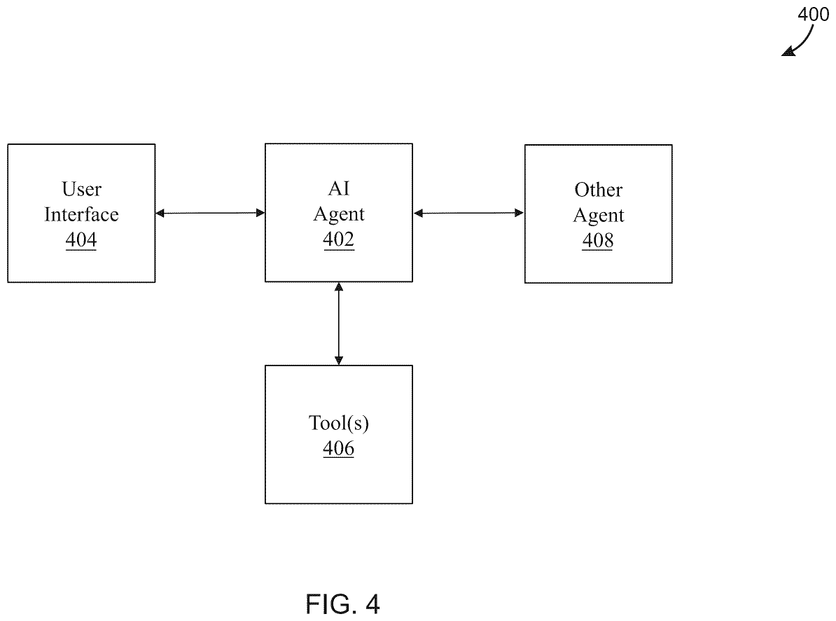

FIG. 4 illustrates an example architecture 400 for an artificial intelligence (AI) agent, according to various implementations. At the core of architecture 400 is AI agent 402, which may be implemented through execution of AI process 248.

As shown, AI agent 402 may interact with a user via a user interface 404. For instance, a user may issue a prompt to AI agent 402 that seeks an answer to a question, performance of a certain task, or the like. In turn, AI agent 402 may use its associated model to formulate a response.

Also as shown, AI agent 402 may interact with tools 406. In general, tools 406 may take the form of interfaces that allow AI agent 402 to interact with any number of systems, in its efforts to produce a response for its input request. For instance, tools 406 may allow AI agent 402 to perform searches (e.g., web searches, searches within a given application or database, etc.), send control commands, or perform other actions, as needed.

In various implementations, AI agent 402 may also be part of an agentic system whereby multiple AI agents interact with one another to formulate a response to an input request. Indeed, the tools, models, etc. available to any given agent may differ across the agentic system. Consequently, different agents may have different capabilities and specialties. Thus, in some implementations, AI agent 402 may also interact with other agent 408, to aid in formulating a final response to its input request. Typically, other agent 408 is executed by a different device than that of the device execution AI agent 402, meaning that AI agent 402 and other agent 408 may communicate via a computer network. In other implementations, though, both agents may be executed by the same device, in further implementations.

For instance, assume that other agent 408 uses a model that has be specialized using knowledge about computer networks and interfaces with tools capable of interacting with a computer network (e.g., to retrieve information, make configuration changes, etc.). Now, assume that the user of user interface 404 issues a query to AI agent 402 asking why the performance of their videoconferencing application is poor. Further, assume that AI agent 402 uses a model that has been specialized on knowledge about the videoconferencing application and able to interact with that application via tools 406. If its initial assessment of the operation of the videoconferencing application is that everything appears to be performing well at the server level, AI agent 402 may then issue a request to other agent 408, to see whether the root cause of the poor performance is the computer network itself.

As noted above, computer networks and other complex systems often produce a large amount of operational data, presenting challenges with respect to analyzing this data in a meaningful and timely manner. For instance, in the case of computer networks, network devices, controllers, monitoring tools and other devices/services associated with the network typically produce a vast array of operational data that is referred to herein as “events” for simplicity. Events need to be analyzed and evaluated across multiple dimensions to get a holistic idea of their impact on the network. However, below illustrates the diversity of types of events in this context and their possible underlying relationships, among others:
events that are occurring discreetly on the same time across multiple days
multiple types of events occurring at the same time
high volume/sudden bursts of the same event type happening in a small-time interval
events that impact specific levels of the networking stack e.g., the application layer, the network layer etc.
events that impact a subset of sites or specific device types only

All these different dimensions make it difficult for a human operator to assess the events and get a clear picture of the status of the computer network. The latest advancements in LLMs have made the task of automatic text summarization possible with particularly satisfactory results. However, the task of summarizing network event data is distinctly different from summarizing conventional text due to a variety of inherent challenges:
Technical vocabulary: network events are often described using specialized technical terminology that may not be part of the standard training data for most LLMs. This domain-specific jargon requires the model to have a deep understanding of the context to generate accurate summaries.
Non-textual data: unlike straightforward text, network data often contains non-textual elements such as timestamps, IP addresses, numerical values, and encoded messages that need to be interpreted correctly and integrated into the summary in a meaningful way.
Event correlation: network events do not occur in isolation. Indeed, they are often interconnected. An LLM must be made aware of these complex relationships between events to produce a coherent and comprehensive summary.
Data volume and velocity: the sheer volume and high velocity of network event data can be overwhelming even for LLMs. Summarizing this information effectively requires robust filtering and prioritization mechanisms to identify and focus on the most critical aspects.
Stability and consistency: producing stable and consistent summaries over time is challenging, especially with the risk of LLM hallucinations.

Addressing these challenges requires a sophisticated architecture that not only pre-processes and structures data for LLM input but also incorporates advanced understanding of network semantics and contextual analysis to generate effective and meaningful summaries of network events.

### Generating Meaningful System Event Summaries Using an LLM

The techniques herein introduce an approach that condenses events associated with a monitored system into natural language summaries, leveraging a customized LLM or other generative model. In some aspects, the techniques herein present a multi-step architecture that meticulously prepares, reduces, and organizes event data before inputting them into the LLM for summarization. In this way, the proposed system enhances output quality and produces accurate, effective summaries that could facilitate the work of any network operator and allow for timely issue identification and resolution.

Illustratively, the techniques described herein may be performed by hardware, software, and/or firmware, such as in accordance with AI process 248, which may include computer executable instructions executed by the processor 220 (or independent processor of interfaces 210) to perform functions relating to the techniques described herein.

Specifically, according to various implementations, a device extracts event data from logs generated by one or more entities in a computer network that are indicative of events that occurred in the computer network. The device detects, using the event data, a relationship between the events that occurred in the computer network. The device generates, based on the relationship, a prompt for input to a language model. The device provides the prompt to the language model, to generate a summary of the events that occurred in the computer network.

Operationally, addressing the above challenges requires a sophisticated architecture that not only pre-processes and structures data for LLM input, but also incorporates advanced understanding of network semantics and contextual analysis to generate effective and meaningful summaries of network events. To this end, the proposed solution is a framework that is meticulously crafted to address these points by performing the following key functions:
event preprocessing to ensure correct representation of non-textual and domain specific fields
event analysis through a multi-dimensional lens, guaranteeing a comprehensive representation of complex network behaviors and a volume reduction
accurate and informative LLM prompt design to allow for high quality summaries
precise and robust validation of the generated summaries that incorporates user feedback

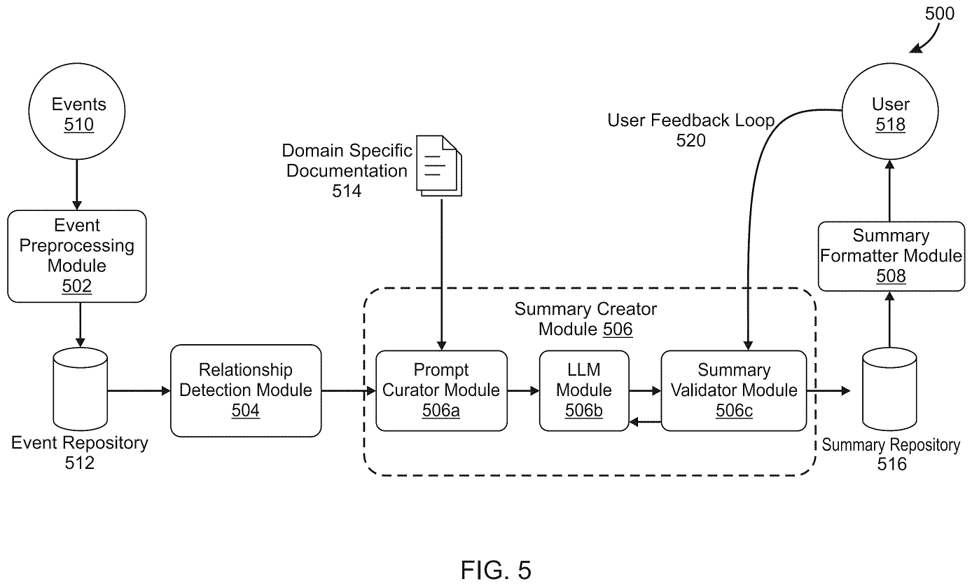

FIG. 5 illustrates an example architecture 500 for generating meaningful system event summaries using a large language model (LLM), according to various implementations. At the core of architecture 500 is AI process 248, which may include any or all of the following components: an event preprocessing module 502, a relationship detection module 504, a summary creator module 506, and/or a summary formatter module 508. As would be appreciated, the functionalities of these components may be combined or omitted, as desired. In addition, these components may be implemented on a singular device or in a distributed manner, in which case the combination of executing devices can be viewed as their own singular device for purposes of executing AI process 248.

In various implementations, event preprocessing module 502 may collect and prepare events 510 regarding the monitored system. The events could be generated by diverse sources and event preprocessing module 502 may provide a common interface for processing them before they are stored in event repository 512. For instance, events 510 may take the form of logs, system statuses, and the like, that events 510 may obtain on a pull or push basis, as desired. In the case of a computer network, for example, event preprocessing module 502 may obtain events 510 directly from the networking equipment in the network (e.g., routers, switches, etc.), from a network controller, or any other potential source for information regarding the current and/or historical state of the computer network.

After collection, event preprocessing module 502 may also augment the data for events 510 using additional sources and standardize it for uniform representation. To do so, event preprocessing module 502 may process and enrich non-textual fields in events 510 appropriately. In addition, event preprocessing module 502 may remove unnecessary fields, duplicate entities, and/or overlapping attributes in events 510 to produce a clean event representation. Further, event preprocessing module 502 may also create embeddings, whenever appropriate, for different attributes of the data to facilitate future event retrieval. The individual attribute embeddings can be further concatenated with appropriate weights to create a representation for the whole event. If necessary, event preprocessing module 502 could apply quantization to these embeddings to optimize dimensionality and storage demands. Finally, to ensure the scalability of the proposed architecture, event preprocessing module 502 may include a pluggable interface that can easily extend to newer sources of events in the future as more events are plugged into the overall summarization workflow.

Once event preprocessing module 502 has processed events 510, it may store the resulting information in event repository 512. Generally, event repository 512 may store both the raw event data and its corresponding vector representation. In some implementations, event repository 512 may also allow for hybrid neural search which allows for both normal search filtering and vector-based searching, such as approximate nearest neighbors. Event repository 512 may also be built for scale, being capable of storing potentially billions of events, while also allowing for efficient sub-second latency search operations.

Relationship detection module 504 may be responsible for identifying relations among the events in event repository 512 and assessing the complex network dynamics, to demystify them. TO do so, relationship detection module 504 may pulls the events that belong to specific time windows from event repository 512 and organize them in groups that highlight their intrinsic connections. Such groups include but are not limited to:
Events that do not occur in isolation but are linked by a common cause, influence, or outcome. These events tend to arise in conjunction with one another, often within specific periods, indicating a relationship that goes beyond mere coincidence.
Events that happen repeatedly over time, following a discernible pattern or cycle.
Events that are localized in terms of the affected network stack, affected devices or sites.

The grouping is based on the event attributes, and relationship detection module 504 can employ the original data representation or their embeddings in event repository 512. To identify the groups, relationship detection module 504 could leverage a machine learning approach such as k-NN, clustering, graph community detection, label propagation or the like. In another implementation, relationship detection module 504 could use a grouping strategy that incorporate additional data into the system like hierarchical clustering could be considered. The hierarchy can be based on the event attributes, time, or both. In all cases, relationship detection module 504 need to be calibrated based on the nature of the targeted groups and they can be extended to any group definition that is important for the underlying technical domain. The creation of groups allows for better control on the summary generation and its validation.

Once the groups are detected, relationship detection module 504 may provide them as input to summary creator module 506. In general, summary creator module 506 is responsible for producing the summaries per group. The goal of a group summary is to highlight the common characteristics among the events in the group in a concise way and to present the underlying event connections in a simplified way. In various implementations, summary creator module 506 may achieve this through the execution of any or all of the following sub-components: prompt curator module 506a, LLM module 506b, and/or summary validator module 506c, the functionalities of which may be combined or omitted, as desired.

In various implementations, prompt curator module 506a is responsible for formulating an effective prompt for the LLM of LLM module 506b. More specifically, the prompt needs to incorporate all relevant event information, while also excluding attributes that do not offer much as this increases the prompt size without any benefits. In one implementation, prompt curator module 506a may leverage Retrieval Augmented Generation (RAG) to assist with retrieving high quality explanations for the events'attributes and their values. RAG can also help with simplifying technical jargon by providing explanations for terms that are not considered common knowledge within the prompt, such as based on domain specific documentation 514. This kind of domain specific knowledge is usually not available on the Internet and cannot be expected to be part of the training data of generic LLMs. On the other hand, this kind of information is important for correctly identifying underlying commonalities in the events and identifying hidden connections.

In another implementation, prompt curator module 506a may adjust the template for the prompt to the types of the events in each group. Events are usually labelled based on the network component they are more relevant to and different prompts may be appropriate in each case.

In yet another implementation, prompt curator module 506a may compute and incorporate statistics over the attributes of the events in the group into the prompt. The statistics can be used alongside the raw event data or even in isolation to reduce the input prompt size while focusing the LLM input on the most important aspects of the group. In another implementation, prompt curator module 506a could represent the groups only by the most characteristic events in the group, the leaders, to ensure appropriate prompt size and focus of the content. Finally, prompt curator module 506a could also leverage popular libraries like LangChain to break down long prompts into a series of prompts that would achieve the same end goal of an effective group summary.

Once the prompt is formulated, prompt curator module 506a provides it to LLM module 506b for input. This module's purpose is simple: it takes an input prompt, passes it through a LLM and captures the output. LLM module 506b then sends the resulting summaries to summary validator module 506c for assessment.

Generally, summary validator module 506c is responsible for ensuring that the produced summaries are of high quality and accuracy. To this end, summary validator module 506c may ensure that they fulfill some criteria such as:
referencing required information that is critical for the business or technical domain,
consistent summary structure across the groups
accurate information based on the input data and no hallucinations
appropriateness of the used language (no sexist or racist content) etc.,
correct context that does not deviate from predefined goals for summaries

In one implementation, summary validator module 506c may verify some of the above criteria by employing a second LLM as a judge. In another implementation, summary validator module 506c may employ a coding library for text similarity to verify consistency between the information in the input data and the produced summaries. For the case of general text appropriateness and context checking, summary validator module 506c could leverage external services like Microsoft Azure Guardrails, Amazon Bedrock Guardrails, or even open-source libraries designed specifically for this purpose. In yet another implementation, summary validator module 506c could also rely on a user feedback loop 520 with a user 518, to evaluate the LLM outputs and provide extra guidelines for the summary validation.

Before the summaries are presented to a user such as user 518 (e.g., on request), summary creator module 506 may store them in a summary repository 516. In turn, summary formatter module 508 may further process the summaries and present the results to user 518. During this formatting, summary formatter module 508 may modify a summary into a user-friendly format and/or enrich it with additional elements that could enhance the user experience like plots, hyperlinks to detailed descriptions of the grouped events, etc.

In turn, summary formatter module 508 may provide the resulting event summaries to user 518 for review via a user interface. As noted, in some implementations, user 518 may also provide feedback on the produced summaries through user feedback loop 520 regarding either the content or formatting of the summary. This feedback is then communicated back to summary validator module 506c to allow for better calibration of the validation process.

In further implementations, summary formatter module 508 may provide event summaries to a system to perform automated remediation actions based on the summaries. For instance, in the case of a computer network, the event summaries could potentially drive automated configuration changes in the network (e.g., routing changes, device reconfigurations, etc.).

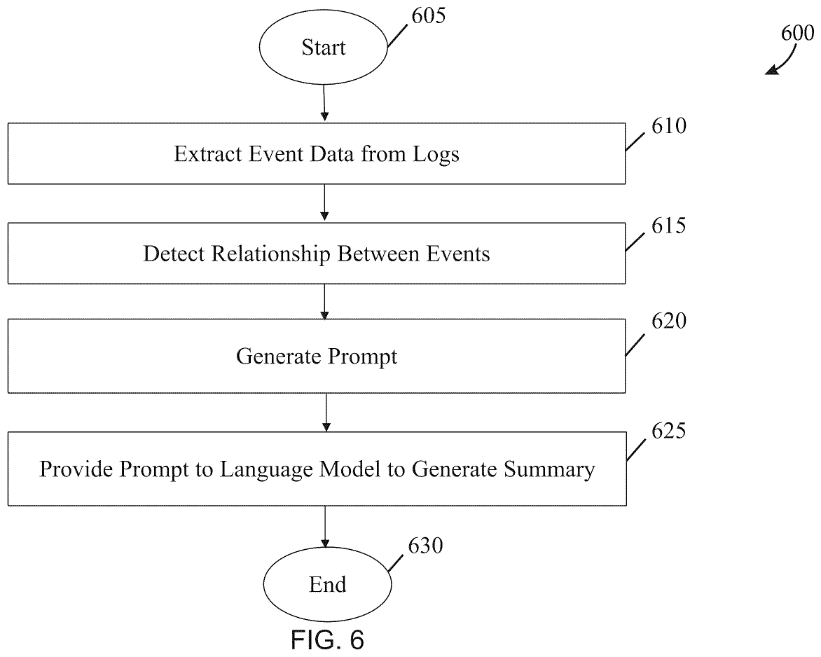

FIG. 6 illustrates an example of a simplified procedure for generating meaningful system event summaries using an LLM, in accordance with one or more implementations described herein. For example, a non-generic, specifically configured device (e.g., device 200), may perform procedure 600 (e.g., a method) by executing stored instructions (e.g., AI process 248). The procedure 600 may start at step 605, and continues to step 610, where, as described in greater detail above, the device (e.g., a controller, server, etc.) may extract event data from logs generated by one or more entities in a computer network that are indicative of events that occurred in the computer network. For instance, the one or more entities in the computer network may include at least one of: a router, a switch, or an access point. In some implementations, the logs comprise unstructured text. In further implementations, the device may extract the event data by removing duplicate entries, overlapping attributes, or unnecessary fields from the logs.

At step 615, as detailed above, the device may detect, using the event data, a relationship between the events that occurred in the computer network. In various implementations, the device detects the relationship between the events based on at least one of: their periodicity or a common location in the computer network.

At step 620, the device may generate, based on the relationship, a prompt for input to a language model, as described in greater detail above. In various implementations, the language model is a large language model (LLM). In some implementations, the device generates the prompt in part by inserting text from one or more reference documents regarding computer networking into the prompt. In one implementation, the device may also insert text from one or more reference documents regarding computer networking into the prompt (e.g., using a RAG mechanism).

At step 625, as detailed above, the device provides the prompt to the language model, to generate a summary of the events that occurred in the computer network. In turn, in some implementations, the device may also provide the summary to a user interface for review. In addition, the device may also adjust how the device generates event summaries using the language model based on feedback for the summary from the user interface. In some cases, the device may provide a generated plot or a hyperlink in conjunction with the summary of events to the user interface.

Procedure 600 may then end at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for generating meaningful system event summaries using an LLM, it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
extracting, by a device, event data from logs generated by one or more entities in a computer network that are indicative of events that occurred in the computer network;
detecting, by the device and using the event data, a relationship between the events that occurred in the computer network;
generating, by the device and based on the relationship, a prompt for input to a language model; and
providing, by the device, the prompt to the language model, to generate a summary of the events that occurred in the computer network.

2. The method as in claim 1, wherein the logs comprise unstructured text.

3. The method as in claim 1, wherein the language model is a large language model (LLM).

4. The method as in claim 1, wherein generating the prompt comprises:
inserting text from one or more reference documents regarding computer networking into the prompt.

5. The method as in claim 1, further comprising:
providing the summary to a user interface for review.

6. The method as in claim 5, further comprising:
adjusting how the device generates event summaries using the language model based on feedback for the summary from the user interface.

7. The method as in claim 5, further comprising:
providing a generated plot or a hyperlink in conjunction with the summary of events to the user interface.

8. The method as in claim 1, wherein the device detects the relationship between the events based on at least one of: their periodicity or a common location in the computer network.

9. The method as in claim 1, wherein extracting the event data from the logs generated by the one or more entities in the computer network comprises:
removing duplicate entries, overlapping attributes, or unnecessary fields from the logs.

10. The method as in claim 1, wherein the one or more entities in the computer network comprise at least one of: a router, a switch, or an access point.

11. An apparatus, comprising:
one or more network interfaces;
a processor coupled to the one or more network interfaces and configured to execute one or more processes; and
a memory configured to store a process that is executable by the processor, the process when executed configured to:
extract event data from logs generated by one or more entities in a computer network that are indicative of events that occurred in the computer network;
detect, using the event data, a relationship between the events that occurred in the computer network;
generate, based on the relationship, a prompt for input to a language model; and
provide the prompt to the language model, to generate a summary of the events that occurred in the computer network.

12. The apparatus as in claim 11, wherein the logs comprise unstructured text.

13. The apparatus as in claim 11, wherein the language model is a large language model (LLM).

14. The apparatus as in claim 11, wherein the apparatus generates the prompt by:
inserting text from one or more reference documents regarding computer networking into the prompt.

15. The apparatus as in claim 11, wherein the process when executed is further configured to:
provide the summary to a user interface for review.

16. The apparatus as in claim 15, wherein the process when executed is further configured to:
adjust how the apparatus generates event summaries using the language model based on feedback for the summary from the user interface.

17. The apparatus as in claim 15, wherein the process when executed is further configured to:
providing a generated plot or a hyperlink in conjunction with the summary of events to the user interface.

18. The apparatus as in claim 11, wherein the apparatus detects the relationship between the events based on at least one of: their periodicity or a common location in the computer network.

19. The apparatus as in claim 11, wherein the apparatus extracts the event data from the logs generated by the one or more entities in the computer network by:
removing duplicate entries, overlapping attributes, or unnecessary fields from the logs.

20. A tangible, non-transitory, computer-readable medium storing program instructions that cause a device to execute a process comprising:
extracting, by the device, event data from logs generated by one or more entities in a computer network that are indicative of events that occurred in the computer network;
detecting, by the device and using the event data, a relationship between the events that occurred in the computer network;
generating, by the device and based on the relationship, a prompt for input to a language model; and
providing, by the device, the prompt to the language model, to generate a summary of the events that occurred in the computer network.
